(19) United States
(12) Patent Application Publication
(10) Pub. No.: US 2006/0289577 A1
(43) Pub. Date: Dec. 28, 2006

(54) Universal attachment system

(76) Inventor: Larry D. Malone, Cape Elizabeth, ME (US)

Correspondence Address: BOHAN, MATHERS & ASSOCIATES, LLC, PO BOX 17707, PORTLAND, ME, 04112-8707, US

(21) Appl. No.: 11/159,582

(22) Filed: Jun. 23, 2005

(51) Int. Cl. B60R 9/00

(52) U.S. Cl. 224/323; 224/325

(57) ABSTRACT

A universal adapter device and a universal attachment system for securing a carrier to any number of types of roof racks having round, square, rectangular, or oval crossbars. The universal attachment system has two adapter devices, each with a mounting surface having a contour capable of receiving and securing a crossbar of round, oval, square, or rectangular shape. The two devices are fastened tightly together around the crossbar, to provide a secure mount for a carrier or other frame. One of the two parts may be integrated into the mounting surface of a carrier. The other of the two parts is a universal adapter device that may be used with other carrier mounting hardware.

### FIELD OF THE INVENTION

The present invention relates to the field of attachment systems. More particularly, the invention relates to attachment systems to secure carriers onto any one of a number of different types of roof racks, such as onto an automobile roof rack.

### DESCRIPTION OF THE PRIOR ART

Vehicles are frequently equipped with roof racks so as to provide a stable base for carriers, which provide a secure means of transporting cargo or gear that is best transported on the roof of the vehicle, such as skis, a snowboard, a bicycle, a surfboard, or a canoe. The roof racks may be incorporated into the roof structure of the vehicle by the automobile manufacturer when the vehicle is made, or mounted on the vehicle roof as an after-market accessory. The roof racks may be permanently or removably affixed to a vehicle. The typical factory-installed roof rack has side bars that run longitudinally along the roof and crossbars that extend across the side bars. The typical after-market roof rack generally has crossbars that are mounted on the factory-installed side bars or that clamp directly to the vehicle roof. Carriers for transporting cargo or gear are typically mounted on the crossbars.

Specific types or makes of carriers are generally required to secure oversized or odd shaped gear, such as skis, bicycles, canoes, or kayaks, to the roof rack. Thus, people frequently acquire multiple carriers, either because they have multiple pieces of gear and each piece of gear requires its own specific carrier, or because they wish to transport their gear on multiple vehicles. The crossbars of the roof racks provided by the various manufacturers are not standardized and vary in contour and dimension. For example, Yakima Products, Inc. manufactures a roof rack with round crossbars, Thule AB manufactures a roof rack with square crossbars, and Ford Motor Corporation and Nissan Motor Corporation manufacture roof racks of different dimensions with oval crossbars. Thus, the carrier designed to seat securely on a roof rack with rectangular or square crossbars, may not seat securely on a roof rack made with round or oval crossbars. This presents a problem to the owner of multiple vehicles, who presently may have to acquire a different carrier or attachment means for the carrier for each vehicle on which the gear is to be transported. Thus, if a canoe is to be transported at times on two vehicles with different roof racks, two different canoe carriers or cradles with two different attachment systems may be needed

U.S. Pat. application Ser. No. 6,681,971 Laverack et al., 2004) discloses a “securement arrangement” that is a clamshell type clasp. Each half of the clasp has an internal recess in which rubber “fitting members” are insertable. The fitting members are selected and arranged in the recess to accommodate the particular contour of the crossbar on which the clasp is to be mounted. Thus, the clasp is adaptable to rectangular, round, elliptical, oval, airfoil or irregularly shaped crossbars. This clasp has several disadvantages: it is structurally complex and, therefore, relatively costly to manufacture; and it's assembly requires that multiple parts be assembled in a series of steps.

U.S. Pat. application Ser. No. 6,322,279 (Yamamoto et al., 2001) discloses an adjustable attachment mount that is adaptable to various contours of the crossbar. A strap loops around the bottom half of the crossbar to secure the carrier to it. The disadvantages of this invention are: it is complex to manufacture; and, due to the winding and ratcheting mechanism of the device, it is difficult to securely fix the device to and then release it from the crossbar. Either the device is ratcheted very tightly about the crossbar, making it difficult to release, or is slightly loose, providing an insecure mount for the device carrier.

U.S. Pat. application Ser. No. 0,040,139 (Dean et al., 2001) discloses a bicycle carrying rack that includes a fork block (FIG. 3). The fork block includes a two-piece clasp that fits around the crossbars of the roof rack. Each piece of the clasp has a channel shaped to accommodate a rectangular crossbar. Reinforcing ribs in the channel allow the clasp to fit around a round crossbar. The clasp will not rotate about a rectangular crossbar, because of the change in contour, but will rotate about a round crossbar. To prevent this, a series of teeth are provided in the reinforcing ribs that bite into the soft pliable coating that is typically provided on the crossbars. The disadvantage of this invention is that it does not accommodate oval crossbars and may damage the round crossbar coating when used in locations where the temperatures are high.

What is needed, therefore, is an attachment system that will fit, without modification, on a roof rack crossbar of square, rectangular, round, oval, or other contour. What is further needed is such a system that is quickly and easily attachable to and removable from the crossbar. What is yet further needed is such a system that is simple in design and to manufacture.

### BRIEF SUMMARY OF THE INVENTION

The present invention is a universal attachment system comprising a first adapter device and a second adapter device, which together form a crossbar cavity that accommodates a crossbar of rectangular, square, round, oval, or other contour. The first and second adapter devices are fastened together with fasteners and nuts. Roof racks vary in size and dimension, and the crossbar may have a rectangular, square, round, oval, or other contour. The universal attachment system according to the invention provides a means to secure various carrier devices onto a crossbar of most conventional roof racks, without modification. Examples of such carrier devices include, but are not limited to, carrier devices for bicycles, kayaks, surf boards, snowboards, skis, cargo, etc.

The first adapter device has a first mounting surface and the second adapter device a second mounting surface. Each mounting surface has a contour, flanked on each end by a fastening flange. The contour is a multi-faceted surface that, when the two devices are mated together, allows the attachment system to securely seat on a crossbar that has a rectangular, square, round, oval, or other contour. A device carrier or cradle, e.g., a bicycle carrier, kayak carrier, or cargo carrier, may be attached to the upper side of the first or second adapter device, or the first or second adapter device may be integrated into the lower surface of the device carrier or cradle. When the flanges of the first and second adapter devices are aligned facing each other, the first and second mounting surfaces form a crossbar cavity that partially fits around and clasps variably sized crossbars having a contour that is round, square, rectangular, oval, or other.

Mounting the universal attachment system to the crossbar is a simple task, requiring only a wrench. To assemble the universal attachment system, the first adapter device is placed on one side and the second adapter device on the other side of the crossbar, so that the cavity formed by the two adapter devices at least partially surrounds the crossbar. The flanges of the first and second adapter devices are tightly and securely fastened to each other by fasteners inserted through corresponding bores provided in the flanges. The length of the fasteners may vary, depending upon the thickness of the crossbar. The wrench is used to tighten the nuts on the fasteners until the second adapter device slightly bows towards the first adapter device. This causes the universal attachment system to clamp tightly to the crossbar. The universal attachment system may be easily and quickly disassembled by reversing the installation procedure.

The first and second adapter devices may be constructed of any rugged and form-rigid material that is suitable for tightly clamping on to a bar. Although the scope of the invention is not limited to a particular type of material, one or both of the first and second adapter devices are ideally constructed of a metal, such as extruded aluminum, which is coated with a plastic or rubber protective coating to prevent damage to the items being carried. If one of the adapter devices is integrated into a carrier, it may be made of a plastic material, such as a polypropylene or a polycarbon plastic that has the strength and rigidity necessary to securely mount the carrier. The fasteners are constructed of non-corroding stainless steel to resist corrosion.

### BRIEF DESCRIPTION OF THE DRAWINGS

The present invention is described with reference to the accompanying drawings. In the drawings, like reference numbers indicate identical or functionally similar elements.

FIG. 1 is an elevational view of the universal attachment system

FIG. 2A shows the universal attachment system of FIG. 1 assembled on a round crossbar.

FIG. 2B shows the universal attachment system of FIG. 1 assembled on a square crossbar.

FIG. 2C shows the universal attachment system of FIG. 1 assembled on an oval crossbar.

FIG. 3 is a perspective view of the universal attachment system with a sample carrier.

### DETAILED DESCRIPTION OF THE INVENTION

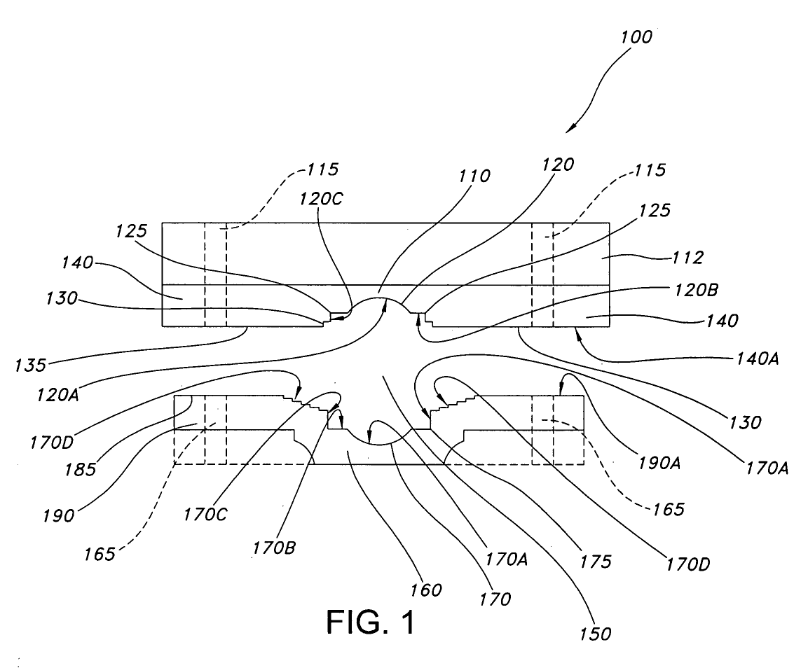

FIG. 1 illustrates a cross-sectional view of a universal attachment system 100, which comprises a first adapter device 110, a second adapter device 160, and a fastener 240. In the embodiment shown, the first adapter device 110 is incorporated into the mounting surface of a cargo or gear carrier 112 and the second adapter device 160 is a universal bar or block that is attachable to the first adapter device 110 or to some other device. The gear carrier 112 may be any type of carrier for mounting on a roof rack and is shown here schematically merely to illustrate that the first adapter device 110 may be incorporated into the structure of another device. The roof rack referred to herein is a conventional roof rack having at least two crossbars. The tem “roof rack” as used hereinafter shall refer to a roof rack that is incorporated into the structure of the vehicle roof at the time of manufacture and that consists of crossbars mounted directly on the roof, with or without side bars, as well as to a conventional after-market roof rack that is removably assembled on the vehicle roof. The term “crossbars” shall refer to the bars onto which the gear carrier 112 is mounted and shall not limit the installation of the crossbar to any particular orientation.

The first adapter device 110 has a first mounting surface 135 that includes a first contour 120 flanked on each side by a first flange 140 with a first flange face 140A. The first contour 120 is a multi-faceted surface that includes a first curved facet 120A, a first horizontal facet 120B and a first vertical facet 120C with a first square corner 125 therebetween, and a step 130. The second adapter device 160 has a second mounting surface 185 that includes a second contour 170 flanked on each side by a second flange 190 with a second flange face 190A The second contour 170 is also a multi-faceted surface, which includes a second curved facet 170A, a second horizontal facet 170B and a second vertical face 170C with a second square corner 175 therebetween, and a shoulder facet 170D. The shoulder facet 170D may have serrations or a stairstep contour, as shown, or have an incline without serrations. In the embodiment shown, the second adapter device 160 has a contoured lower surface 166 that increases the ability of the second adapter device 160 to accommodate the various thicknesses of a wide range of factory rooftop racks. This contoured lower surface may not be necessary for the particular application of the second adapter device 160, in which case the lower surface 166 may have a simpler, easier to manufacture block shape, as indicated by the dashed lines. A first bore 115 is provided through the first flange 140 and a second bore 165 through the second flange 190. Upon assembly, the first and second bores 115 and 165 align with each other and allow a fastener 240 to be inserted therethrough.

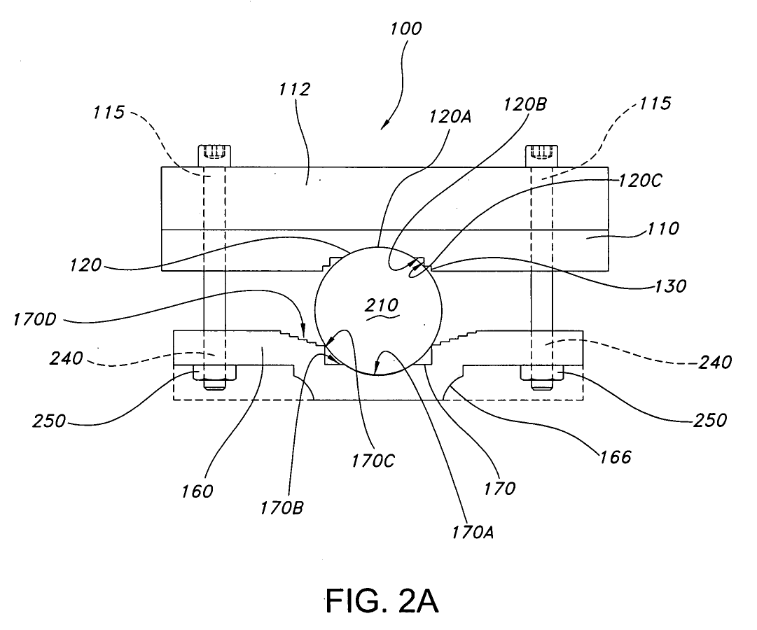

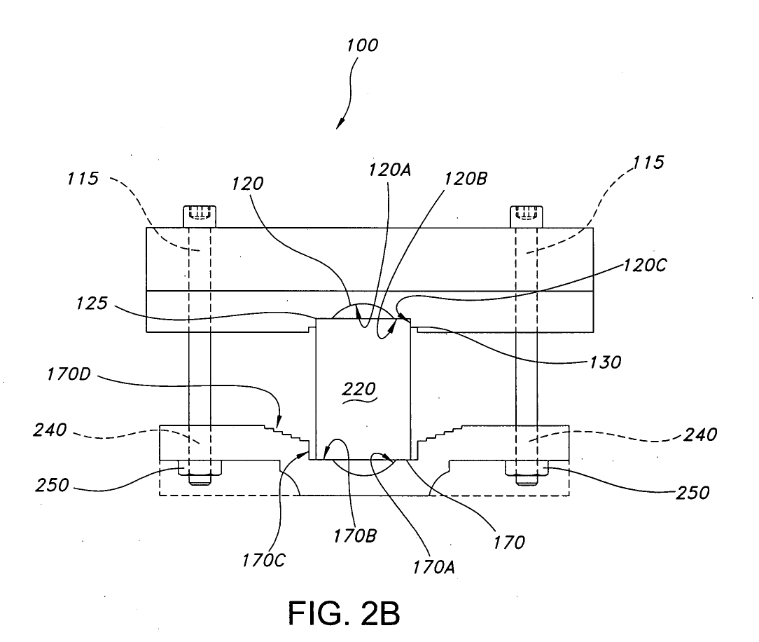

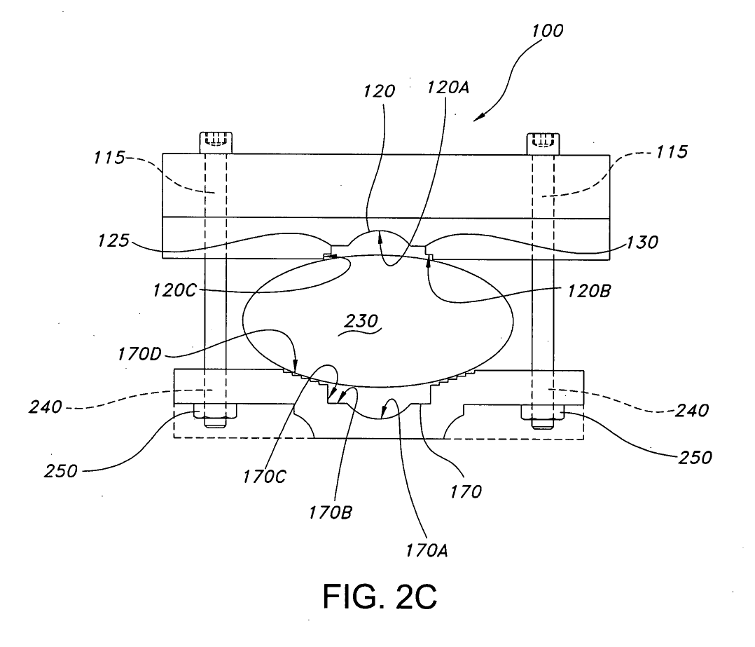

The utility of the various facets is best illustrated in FIGS. 2A-2C. The first and second mounting surfaces 135 and 185 create a crossbar-receiving aperture 150, which fits around and surrounds a crossbar. The first and second curved facets 120A and 170A, respectively, align opposite each other and form an aperture having upper and lower limits that correspond to the perimeter of a circle. These first and second curved facets 120A, 170A partially surround a round crossbar 210, such as one provided by the Yakima Products, Inc., and shown in FIG. 2A. On each side of the curved facets 120A, 120B, the first horizontal facet 120B and first vertical facet 120C form the square corner 125. The step 130 connects the vertical facet 120C to the first flange face 140A. Similarly, the second horizontal facet 170B and the second vertical facet 170C form the second square corner 175. The second vertical facet 170C connects to shoulder facet 170D. These horizontal and vertical facets 120B, 170B, 120C, and 120C, respectively, provide a secure seating for a rectangular crossbar 220, such as one provided by the Thule AB. The slanted shoulder facet 170D connects the second contour 170 with the second flange face 190A. The aperture 150 bounded by the step 125 and the shoulder facet 170D fits partially around an oval crossbar 230 of various dimensions, such as those provided by Ford Motor Corporation or Nissan Motor Corporation and shown in FIG. 2C.

The universal attachment system 100 is quickly and easily installed. The only tool required is a wrench. To assemble the universal attachment system 100, the first adapter device 110 is placed on one side and the second adapter device 160 placed on the opposite side of the crossbar 210/220/230. The aperture 150 fits partially around the crossbar 210/220/230. The first flange 140 and the second flange 190 are aligned facing each other and the universal attachment system 100 tightly and securely clamped to the crossbar 210/220/230 by conventional fasteners 240 that are inserted through first and second bores 115 and 165 in the corresponding first and second flanges 140 and 190. The fasteners 240 are tightened with nuts 250 until the second adapter device 160 bows slightly towards the first adapter device 110, causing the universal attachment system 100 to firmly and securely clamp to the crossbar 210/220/230. The length of the fasteners 240 may vary, depending upon the thickness of the crossbar. The universal attachment system 100 is easily and quickly disassembled by reversing the installation procedure.

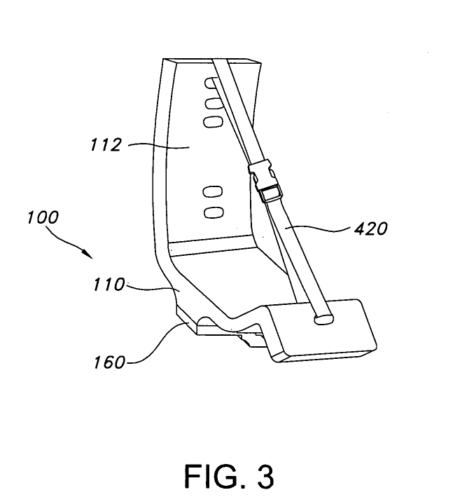

FIG. 3 shows a perspective view of the universal attachment system 100 with a gear carrier 112 representative for securing a kayak (not shown) to the crossbar 210/220/230 (not shown). The gear carrier 112 has slots 410 through which straps 420 are looped. The straps are used to secure the kayak to the gear carrier 112.

The gear carrier 112 and the first adapter device 110 integrated into the carrier 112 are preferably constructed of a plastic, such as a polycarbon or polypropylene plastic. The polycarbon plastic is particularly suitable because, even though it has the strength and rigidity necessary to provide a secure mount for the gear carrier 112, it also has some elasticity, allowing it to absorb road shock and wind shear, and to bend slightly when tightly fastened. The first adapter device 110, particularly if it is a stand-alone device, may be constructed of metal. The second adapter device 160 is preferably constructed of metal, such as extruded aluminum. It is also possible to construct the second adapter device 160 of a plastic material, if the plastic material provides sufficient rigidity, strength, and durability for the intended application of the device 160. Adapter devices 160 and/or 110, if made of metal, are preferably coated with a protective coating, such as a liquid dipped pastic coating or a UV-resistant rubber coating, to prevent damage to items being carried. The fasteners 240 are typically constructed of stainless steel to resist corrosion, and the straps typically of polypropylene and fitted with stainless steel cam style buckles 420. It is understood that other suitable materials may be used for the fasteners and the strap.

The scope of the invention encompasses a universal attachment system as described above, as well as a universal adapter bar that is described as the second adapter device 160 and that is used together with other mounting hardware to attach a carrier to a roof rack. The embodiments of the invention mentioned herein are merely illustrative of the present invention. It should be understood that a person skilled in the art may contemplate many variations in construction of the present invention in view of the following claims without straying from the intended scope and field of the invention herein disclosed.

What is claimed is:

1: A universal adapter device comprising:
a universal bar having a mounting face that includes an adapter contour, flanked on each side by a flange, said adapter contour including a curved facet, a horizontal facet, a vertical facet, and a shoulder facet and said flange having a flange face;
wherein said horizontal facet extends between said curved facet and a first end of said vertical facet, and said shoulder facet extends between a second end of said vertical facet and said flange face.

2: The universal adapter device of claim 1, wherein serrations are provided on said shoulder facet.

3: The universal adapter device of claim 1 further comprising a through-bore in said flange.

4: The universal adapter device of claim 1, further comprising a contoured bottom surface that includes a central bottom surface and a flange bottom surface, wherein said central bottom surface is a first vertical distance from said flange face and said flange bottom surface is a second vertical distance from said flange face.

5: The universal adapter device of claim 4, wherein said second vertical distance is a lesser distance than said first vertical distance.

6: The universal adapter device of claim 1, wherein said universal bar is constructed of a metal material.

7: The universal adapter device of claim 6, wherein said metal is aluminum.

8: The universal adapter device of claim 6, wherein said universal bar is coated with a protective coating.

9: The universal adapter device of claim 6, wherein said universal bar is coated with a rubber material.

10: The universal adapter device of claim 1, wherein said universal bar is constructed of a plastic material.

11: An attachment system comprising:
a first adapter device having a first mounting face that includes a first adapter contour with two first-adapter contour ends and flanked on each of said first-adapter contour ends by a flange having a flange face;
a second adapter device having a second mounting face that includes a second adapter contour with two second-adapter contour ends and flanked on each of said second-adapter contour ends by a flange having a flange face, wherein said second adapter contour includes a curved facet, a horizontal facet, a vertical facet, and a shoulder facet, and wherein said horizontal facet extends between said curved facet and a first end of said vertical facet, and said shoulder facet extends between a second end of said vertical facet and said flange face; and
fastening means for fastening said second adapter device to said first adapter device.

12: The attachment system of claim 11, wherein said adapter contour includes a first-adapter curved facet, a first-adapter horizontal face, a first-adapter vertical facet, and a first-adapter step, said first-adapter horizontal facet extending between said first-adapter curved facet and a first end of said first-adapter vertical facet and said first-adapter step extending between a second end of said first-adapter vertical facet and said first-adapter flange face.

13: The attachment system of claim 11, wherein serrations are provided on said shoulder facet.

14: The attachment system of claim 11, said second adapter device having a contoured bottom surface that includes a central bottom surface and a flange bottom surface, wherein said central bottom surface is a first vertical distance from said flange face and said flange bottom surface is a second vertical distance from said flange face.

15: The attachment system of claim 11, wherein said second adapter device is constructed of a metal material.

16: The attachment system of claim 15, wherein said metal is aluminum.

17: The attachment system of claim 15, wherein said second adapter device is coated with a protective coating.

18: The attachment system of claim 11, wherein said second adapter device is constructed of a plastic material.

19: The attachment system of claim 11, wherein said first adapter device is integrated into a carrier device.
